(19) United States
(12) Patent Application Publication
(10) Pub. No.: US 2026/0131177 A1
(43) Pub. Date: May 14, 2026

(54) HARNESS

(71) Applicant: Amer Sports Canada Inc., North Vancouver (CA)

(72) Inventor: Jason Jeremy Mah, Vancouver (CA)

(73) Assignee: Amer Sports Canada Inc., North Vancouver (CA)

(21) Appl. No.: 18/943,179

(22) Filed: Nov. 11, 2024

(51) Int. Cl. A62B 35/00

(52) U.S. Cl. CPC A62B 35/0012; A62B 35/0025

(57) ABSTRACT

A harness includes a first line and a second line. The first line includes a first side opening, a second side opening, and a first interior between the first side opening and the second side opening. The first line further includes a first portion connected to a waist belt, a second portion forming the first interior, a third portion entering the first interior through first side opening to form a tie-in point eye, a fourth portion exiting the first interior through the second side opening, and a fifth portion connected to a leg loop. The second line includes a sixth portion connected to the leg loop, a seventh portion passing through the first interior of the second portion, and an eighth portion extending along the tie-in point eye within the third portion.

### CROSS-REFERENCE TO RELATED PATENT APPLICATIONS

The present application is related to co-pending U.S. patent application Ser. No. 17/950,302 filed on Sep. 22, 2022, the full disclosure of which is hereby incorporated by reference. The present application is also related to co-pending U.S. patent application Ser. No. 18/942,332 filed on Nov. 8, 2024. The present application is also related to co-pending U.S. patent application Ser. Nos. 18/429,751, 18/429,784 and 18/429,795 filed on Feb. 1, 2024, the full disclosure of which are hereby incorporated by reference.

### BACKGROUND

Harnesses may have a variety of different sizes, shapes and configurations. Harnesses may be used for positioning, suspension and fall protection. Harnesses may be used for activities such as climbing, rappelling, zip lining, bungee jumping and hunting or wildlife observation. During hunting (or wildlife observation) the hunter may use a harness to suspend himself or herself from a tree or other supporting structure.

Harnesses may comprise an assembly of multiple components. Such components may include a waist belt (sometimes referred to as a swami) and leg loops. The waist belt is in the form of a band or loop that wraps around the waist of the person wearing the harness. The leg loops are suspended from the waist belt and receive the thighs of the person wearing the harness.

In many circumstances, such harnesses are utilized in remote and possibly difficult to access geographic locations. As a result, the harness must be packed and transported. In such circumstances, it may be important for the harness to be lightweight and compact for packing and transporting.

### BRIEF DESCRIPTION OF THE DRAWINGS

FIG. 1 the front perspective view of an example harness.

FIG. 2 is a perspective view of the example harness of FIG. 1 with portions schematically illustrated and with portions of an example tie-in riser exploded and shown in section.

FIG. 3 the front perspective view of an example harness.

FIG. 4 is a perspective view of the example harness of FIG. 3 with portions schematically illustrated and with portions of an example tie-in riser exploded and shown in section.

FIG. 5 the front perspective view of an example harness.

FIG. 6 is a perspective view of the example harness of FIG. 5 with portions schematically illustrated and with portions of an example tie-in riser exploded and shown in section.

FIG. 7 is an enlarged perspective view illustrating a portion of the harness of FIG. 5 including an example buckle and buckle receiving connection loop provided by the example tie-in riser.

FIG. 8 is a top perspective view illustrating the example buckle of FIG. 7.

FIG. 9 is a top perspective view illustrating the buckle of FIG. 8 positioned within the example connection loop of FIG. 7.

FIG. 10 is a top perspective view illustrating the buckle of FIG. 9 received within the buckle receiving connection loop of FIG. 9 and further illustrating the buckle receiving connection loop engaged by the buckle.

FIG. 11 is an exploded perspective view illustrating two example lines of the example tie-in riser of FIG. 6.

FIG. 12A is a perspective views illustrating splicing together of the two example lines of FIG. 11 to form the example tie-in riser of FIG. 6.

FIGS. 12B through 12J are perspective views illustrating the assembly of the two example lines of FIG. 11 to form the example tie-in riser of FIG. 6 and FIG. 12A.

FIG. 13 is an exploded perspective view illustrating an example connection scheme for connecting portions of one or more tie-in risers to a waist belt or a leg loop.

FIG. 14 is a sectional view illustrating a portion of the example connection scheme of FIG. 13.

FIG. 15 is an exploded perspective view illustrating an example connection scheme for connecting portions of one or more tie-in risers to a waist belt or a leg loop.

FIG. 16 is a perspective view of a pair of tie-in risers with portions exploded and shown in section, the pair of tie-in risers being connected according to the connection scheme of FIG. 15 to form portions of a waist belt.

FIG. 17 is a perspective view of an example tie-in riser with portions exploded and shown in section, the tie-in riser being connected to an example leg loop according to the connection scheme of FIG. 15.

FIG. 18 is a perspective view of example tie-in riser with portions exploded and shown in section.

FIG. 19 is a perspective view of example tie-in riser with portions exploded and shown in section.

FIG. 20 is a perspective view of example tie-in riser with portions exploded and shown in section.

FIG. 21 is a perspective view of example tie-in riser with portions exploded and shown in section.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are examples of harnesses that offer high-strength and durability and that are, at the same time, compact and lightweight. The example harnesses comprise a waist belt, first and second leg loops, and first and second tie-in risers. Each of the risers extends from a respective leg loop, is connected to the waist belt and provides a tie-in point eye for a belay.

Each of the tie-in risers comprises first and second lines that are spliced together. The leg loop has a first end region and a second end region. The first line has a first portion connected to the waist belt and a second portion connected to a first end region of the associated leg loop. A portion of the first line between the first portion and the second portion forms a loop that serves as the belay tie-in point eye. The second line is connected to the second end region of the associated leg loop and passes along and within the portion of the first line that forms the belay tie-in point eye.

In some implementations, the first line is fixedly or permanently connected to the waist belt. The terms “fixedly” or “permanently” means that two pieces are connected such that they cannot be separated without damaging the connection between the two pieces such that they cannot be readily reconnected without additional glues, bonds, adhesives or pieces. For example, in some implementations, the first line may have a splayed end that is captured or sandwiched between portions of the waist belt. In some implementations, the first line is releasably connected to the waist belt. For example, the first line is connected to the waist belt with a quick release buckle or the like.

In some implementations, the first line is fixedly or permanently connected to the first end region of the associated leg loop. In some implementations, the first line has a splayed end that is captured or sandwiched between portions of the associated leg loop. In other implementations, the first line is releasably connected to the first end region of the associated leg loop. In some implementations, the second line is fixedly connected to the second end region of the associated leg loop. In some implementations, the second line is releasably connected to the second end region of the associated leg loop. For example, in some implementations, the second line is releasably connected to the second end region of the associated leg loop by a quick release or side release buckle. In some implementations, the second line forms a loop is releasably connected to the second end region of the associated leg loop by a loop and a larger header buckle that passes through the loop and is retained within the loop under tension.

In some implementations, the first line forms a connection loop for connection to the first end region of the associated leg loop. For example, in some implementations, the first line forms a connection loop that wraps around a bar of a buckle. In such implementations, the tail is secured to an interior of the second line to form the connection loop. In some implementations, the buckle may be a quick release or side release buckle. In some implementations, the connection loop extends around a bar of a buckle that is sized so as to pass through another connection loop provided on the second end region of the associated leg loop. In yet other implementations, the first line forms a loop that is to receive a larger head or a larger buckle that is retained within the connection loop in a particular orientation and under tension.

In some implementations, the first line has a tail that is secured to another portion of the first line to form the connection loop. In some implementations, the second line has an interior, wherein the tail enters the interior and is secured to the second line to form the connection loop. In some implementations, the first line passes through and within the second line, wherein the tail is secured to an exterior of the second line to form the connection loop. In some implementations, the second line passes through and within the first portion along the length of the connection loop that is to be connected to the first end region of the associated leg loop.

In some implementations, the first line has a portion that forms an interior that receives both another portion of the first line and a portion of the second line. In some implementations, the first line has a portion that receives a first portion of the second line and another portion of the first line, wherein the first portion of the second line has an interior that receives a second portion of the second line and the other portion of the first line.

For purposes of this disclosure, the term “line” refers to a flexible elongate length of one or more materials such as cellulose-based or organic materials or polymer-based materials. A line may be in the form of a cord, rope. A line may be in the form of a band or strap. At least one of the pair of lines forming the example tie-in risers has at least a portion that is tubular (may have a round cross-section or non-round cross-section) or has a hollow interior, wherein the hollow interior is accessed through at least one side entrance or side opening that passes through an outer side wall of the tube (in contrast to an axial end opening). In some implementations, at least one of the two lines may comprise multiple intertwining fibers. In some implementations, at least one of the two lines may be braided. In other implementations, one or both of the two lines may not be fibers, may not be braided or may have other woven or nonwoven configurations.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such a joining may be permanent in nature or alternatively may be removable or releasable in nature.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

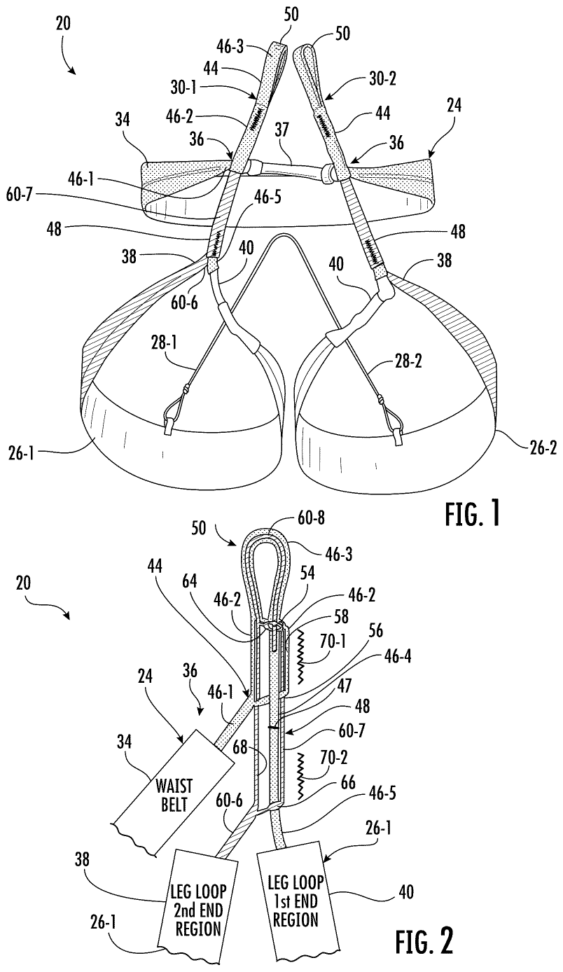

FIG. 1 illustrates portions of an example harness 20 which may offer high-strength and durability while being compact and lightweight. Harness 20 comprises waist belt 24 (sometimes referred to as a swami), leg loops 26-1, 26-2 (collectively referred to as leg loops 26), leg loop risers 28-1, 28-2 and tie-in risers 30-1, 30-2 (collectively referred to as tie-in risers 30). In some implementations, harness 20 may additionally comprise gear loops which hang from waist belt 24 for attachment of gear. In some implementations, harness 20 may comprise additional primary components that encircle or wrap about the shoulders and/or chest of the person wearing harness 20.

Waist belt 24 is configured to support leg loops 26 from the waist of a person wearing harness 20. Waist belt 24 is further configured to be attached to a tether, rope, cable or other flexible line from which waist belt 24 may be suspended from an upper support to limit an extent to which waist belt 24 and the person wearing harness 20 may fall from the upper support. Waist belt 24 comprises band 34 and connector 37.

Band 34 wraps about a majority of the waist of the person wearing harness 20. Band 34 is connected to tie-in risers 30-1 on a front side and is connected to leg loop risers 28 on a rear side. Band 24 has opposite end regions 36 which are connected to one another by connector 37. Although band 34 is illustrated as having a wider rear side that tapers to the front side, tapering to end regions 36, in other implementations, band 34 may have other profiles or shapes.

Connector 37 connects an end region 36 of band 34. In the example illustrated, connector 37 comprises a flexible strap extending between end regions 36. In the example illustrated, connector 37 releasably connects end region 36 to one another. For example, connector 37 may comprise one or more quick release buckles or side release buckles, permitting at least one end of connector 37 to be temporarily disconnected from an end region 36 of band 34.

Leg loops 26 extend from and are suspended from the right and left front sides, respectively, of waist belt 24. Leg loops 26-1 and 26-1 are configured to be wrapped about the right and left thighs, respectively, of the person wearing harness 20. Leg loops 26 are substantially identical to one another. Leg loops 26 each comprise opposite end regions 38 and 40 which are connected to the tie-in riser 30-1 or tie-in riser 30-2. Although each of leg loops 26 is illustrated as having a wider central portion which tapers towards each of end regions 38 and 40, in other implementations, each of leg loops 26 may have other profiles or shapes.

Leg loop risers 28-1 and 28-2 connect and suspend leg loops 26-126-2, respectively, from the rear or back side of band 34 of waist belt 24. In some implementations, risers 28 are provided by a single line having a center portion attached to band 34 and having ends attached to each of leg loops 26-1 and 26-2. In other implementations, risers 28 may be formed from two separate lines extending from waist belt 24 to leg loops 26. In some implementations, leg loop right as 28 may be omitted.

Tie-in risers 30 are each similar to one another. FIG. 2 is a partial sectional view of tie-in riser 30-1. The end region or end 36 of band 34 of waist belt 24 and the end regions 38, 40 of leg loops 26-1 are schematically illustrated in FIG. 2. Tie-in riser 30-1 comprises first and second lines 44, 48 that are spliced together. For purposes of illustration, in FIG. 1, the exposed extents of lines 44 and 48 of tie-in riser 30-1 are indicated by different corresponding stippling. Those portions of lines 44 and 48 of tie-in riser 30-1 that are partially coextensive with band 34 and leg loops 26-1, but internally within the band 34 and leg loop 25 1, are also indicated by the first stippling corresponding to line 44 and a second different stippling corresponding to line 48.

As shown by FIG. 2, the first line 44 has a portion 46-1 connected to the band 34 of waist belt 24 and a portion 46-5 connected to a first end region 40 of the associated leg loop 26-1. A portion 46-3 of the first line 44 between the first portion 46-1 and the second portion 46-5 forms a loop that serves as the belay tie-in point eye 50. The second line 46 is connected to a second end region 38 of the associated leg loop 26-1 and passes along and within the portion 46-3 of the first line that forms the belay tie-in point eye 50.

In the example illustrated, in addition to portions 46-1, 46-3 and 46-5, the first line 44 comprises portions 46-2 and 46-4. Portion 46-2 extends between portions 46-1 and 46-3. Portion 46-2 comprises side entrances or openings 54, 56 and interior 58. Portion 46-4 extends between portion 46-3 and 46-5. Portion 46-4 passes through interior 58, entering interior 58 through side opening 54 and exiting interior 58 through side opening 56.

In the example illustrated, second line 48 comprises portions 60-6, 60-7 and 60-8. Portion 60-6 is connected to end region 38 of leg loops 26-1. Portion 60-7 passes through the interior 58 of portion 46-2 of line 44. Portion 60-8 extends along the tie-in point eye 50 within the interior of portion 46-3. Portion 60-7 extends between portion 60-6 and 60-8. In the example illustrated, portion 60-7 enters interior 58 through side opening 56.

In the example illustrated, portion 60-7 comprises side entrances or openings 64, 66 and an interior 68 between side openings 64, 66. In the example illustrated, side opening 64 is aligned with side opening 54. In the example illustrated, the interior 68 of portion 60-7 is received within the interior 58 of portion 46-2. Portion 46-4 of line 44 enters interior 68 through side openings 64 and exits interior 68 through side opening 66, from which portion 46-5 extends.

In the example illustrated, portion 46-2 is secured to portion 46-4 so as to inhibit relative sliding movement between such portions. Portion 46-2 is further secured to portion 60-7 to inhibit relative sliding movement between such portions. Portion 46-4 is secured to portion 60-7 to inhibit relative sliding movement between such portions. In the example illustrated, a stitch 70-1 extends through and secures portions 46-2, 46-4 and 60-7 to one another against relative sliding movement. In other implementations, multiple stitches may be used to individually secure pairs of portions or groups of portions to one another. In still other implementations, welds, bonds, glues, adhesives or the like may be used to secure such portions to one another.

In the example illustrated, portion 60-7 is secured to portion 46-4 to inhibit relative sliding movement of such portions. In the example illustrated, a stitch 70-2 extends through and secures portion 60-7 and 46-4 against relative sliding movement. In other implementations, welds, bonds, glues, adhesives or the like may be used to secure such portions to one another.

As indicated above, portion 46-1 is connected to band 34, portion 46-5 is connected to end region 40 of leg loops 26-1, and portion 60-6 is connected to end region 38 of leg loops 26-1. Such connections may be permanent in nature or may be releasable in nature. In the example shown in FIGS. 1 and 2, the connections are permanent in nature, meaning that disconnection cannot be made without damaging such connections that may inhibit reconnection. As will be described hereafter, in some implementations, such permanent connections may be facilitated by splayed ends (sometimes referred to as horse tails) which are bonded and/or stitched to portions of the band 34 and/or the leg loops 26-1. For example, portion 46-1 may have a splayed end or horse tail which is integrated into or secured to one or more panels of band 34. Portion 60-6 may have a splayed end or horse tail which is integrated into or secured to one or more panels of end region 38 of leg loops 26-1. Portion 46-5 may have a splayed end or horse tail which is integrated into or secured to one or more panels of end region 40 of leg loops 26-1. In other implementations, portions 46-1, 60-6 and/or 46-5 may be permanently secured or connected to band 34 and leg loops 26-1 in other fashions such as where portions 46-1, 60-6 and 46-5 are rolled or folded and secured to themselves to form connection loops that permanently wrap about bars or rings associated with band 34 or end regions 38, 40 of leg loops 26-1.

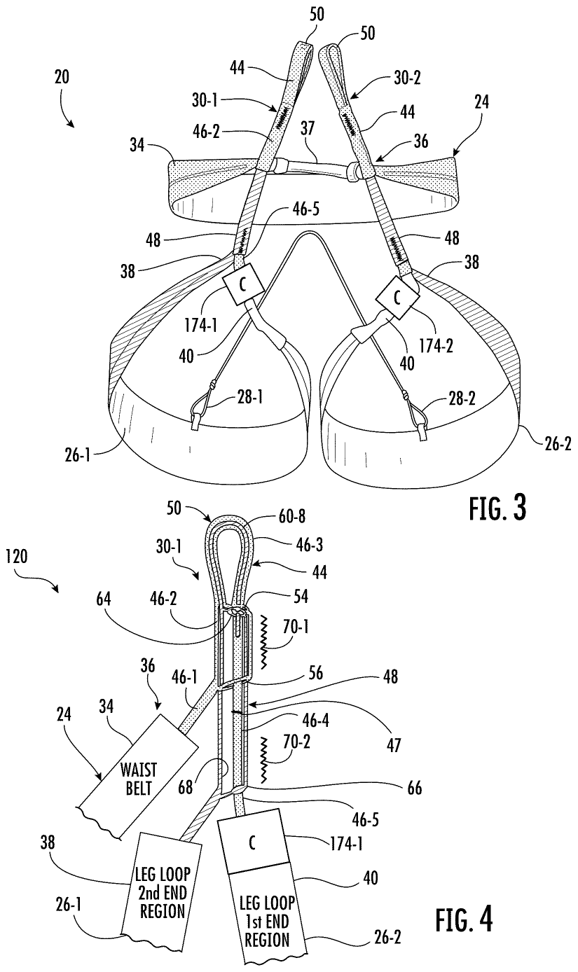

FIGS. 3 and 4 illustrate portions of an example harness 120. Harness 120 is similar to harness 20 described above except that harness 120 is specifically illustrated as additionally comprising connectors 174-1, 174-2 (collectively referred to as connectors 174). Those remaining components of harness 120 to correspond components of harness 20 are numbered similarly.

Connectors 174 (schematically illustrated) releasably connect portions 46-5 of lines 44 to end regions 40 of leg loops 26. In some implementations, connectors 174 each comprise larger catches, heads or buckles that are passed through connection loops in which are retained within such loops to maintain a connection, especially when under tension. Disconnection may be achieved by reducing tension and reorienting the head, catch or buckle to permit the head, catch or buckle to be withdrawn from the connection loop. In some implementations, portion 46-5 may form such a connection loop, wherein the buckle, head, or catch is connected to end region 40 of leg loops 26-1. In other implementations, this relationship may be reversed, where end region 40 of leg loops 26-41 forms a connection loop and wherein a buckle, header catch is secured to portion 46-5. In other implementations, such connections may be made by releasable fasteners. Examples of releasable fasteners include, but are not limited to, quick release or side release buckles having different connector portions secured to end region 40 and portion 46-5.

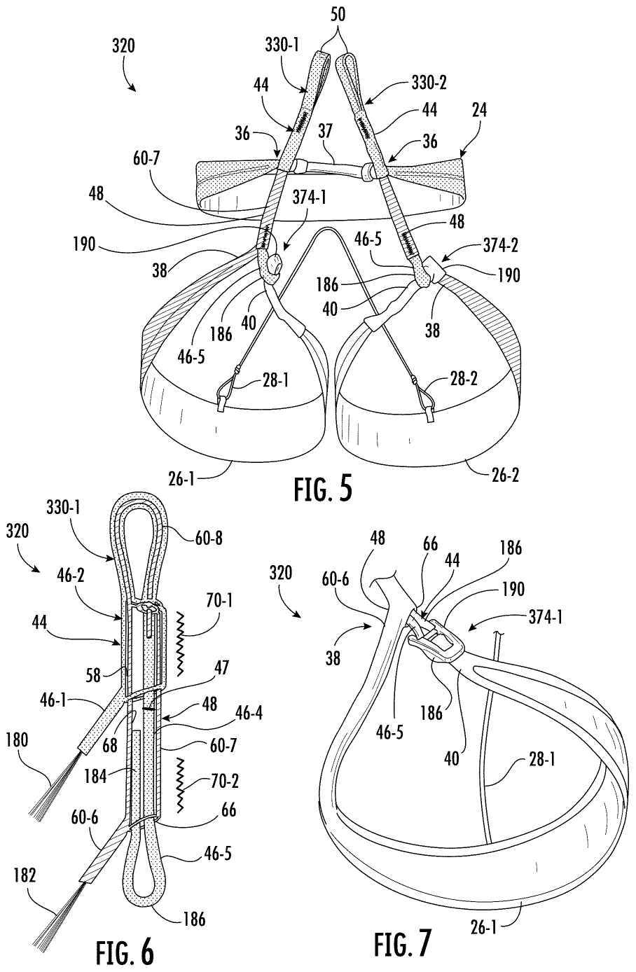

FIGS. 5-7 illustrate portions of an example harness 320. Harness 320 is similar to harness 120 except that harness 320 comprises tie-in risers 330-1, 330-2 and connectors 374-1, 374-2. Tie-in Riser 330-1 is similar to tie-in riser 330-2. FIG. 6 is a partial sectional view illustrating tie-in riser 330-1. Tie-in riser 330-1 is similar to tie-in riser 30-1 except that portion 46-1 of line 44 is specifically illustrated as having a splayed end 180, portion 60-6 of line 48 is specifically illustrated as having a splayed end 182, and that portion 46-5 of line 44 is specifically illustrated as having a tail 184 that forms a connection loop 186 which forms part of connector 374-1. Those remaining components of tie-in riser 330-1 which correspond to components of tie-in riser 30-1 are numbered similarly and are described above. As with FIGS. 1 and 3, for purposes of illustration, in FIG. 5, the exposed extents of lines 44 and 48 of tie-in riser 330-1 are indicated by different corresponding stippling. Those portions of lines 44 and 48 of tie-in riser 330-1 that are partially coextensive with band 34 and leg loops 26-1, but internally within the band 34 and leg loops 26, are also indicated by the first stippling corresponding to line 44 and a second different stippling corresponding to line 48.

Portions 46-1 and 60-6 comprise splayed ends 180 and 182, respectively. Ends 180, 182 each comprises continuous longitudinally extending tension lines (in the form of fibers, yarns, threads or the like) that are condensed or packed until reaching ends 180, 182 where they spread or splay apart in a fan-like pattern. Such splayed tension lines may be secured in place (by stitching, fusing and/or adhesives) to band 34 or the band of leg loops 26-1 so as to extend across and overlap a wider region of band 34 (in the case of end 180) or may extend across and overlap a wider region of end region 38 of leg loop 26-1 (in the case of end 182). When leg loops 26 are placed in tension, such tension forces are spread or distributed across at least a majority of the transverse width of the bands forming belt 24 are leg loops 26, rather than being condensed along a width corresponding to the otherwise narrower widths of portions 46-1 and 60-6.

Tail 184 forms an end of portion 465. Tail 184 reenters the interior 68. In the example treated, tail 184 enters interior succeed through side openings 66. In other implementations, tail 184 may enter interior 68 at other locations. Tail 184 is secured to itself and/or to portion 60-7 to form the connection loop 186. In the example illustrated, stitch 70-2 extends through and secures to 184, portion 46-4 and portion 60-7 to one another. In other implementations, multiple stitches, welds or adhesives may be used to secure such portions to one another and such or to tail 184 to form the connection loop 186.

Connector 374-1 is similar to connector 374-2. Connector 374-1 releasably connects end region 40 of leg loops 26-1 to portion 46-5 of line 44. In the example illustrated, connector 374 comprises the loop 186 formed by the tail 184 of portion 46-5 of line 44, and the illustrated buckle 190. Buckle 190 is connected to end region 40 of leg loops 26-1. Buckle 190 is passable through connection loop 186 such that loop 186 is captured between an underside of buckle 190 and a top side of end region 40.

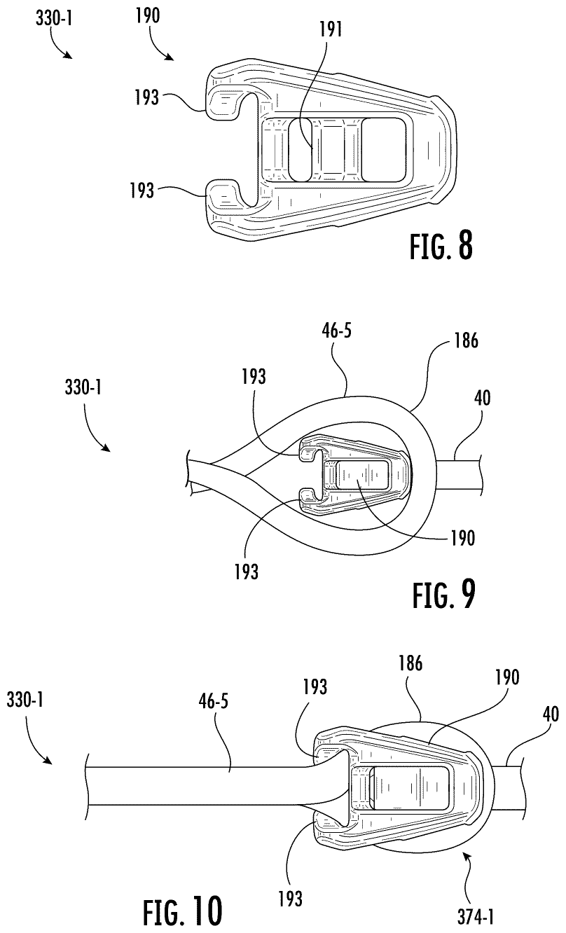

FIGS. 8-10 illustrate the connection provided by connector 374-1 in more detail. FIG. 8 is a top view of buckle 190. FIGS. 9 and 10 illustrate the buckle 190 attached to end region 40 and connected to loop 186. As shown by such figures, end region 40 loops around a bar 191 (shown in FIG. 8) of buckle 190. As shown by FIG. 10, once buckle 190 has been passed through the loop 186, the loop may be pulled beneath buckle 190 (or the buckle 190 pulled over top the loop 186) and passed through and between retention fingers 193 which inhibit accidental disconnection buckle 190 from loop 186.

In other implementations, buckle 190 may have other sizes, shapes and configurations. In yet other implementations, connector 374-1 may have other configurations. For example, in other implementations, connection loop 186 may extend around the bar 191 of buckle 190, wherein end region 40 comprises a loop through which the buckle 190 is inserted in a fashion similar to that shown in FIGS. 9-10. In yet other implementations, loop 186 and buckle 190 may be replaced with another quick release connector, such as a side release buckle or quick connector. In such an implementation, connection loop 186 is connected to a first portion of the side release buckle while end region 40 is connected to the other portion of the side release connector or buckle. In still other implementations, connector 374 may have other configurations or may be replaced with a permanent connection such as described above with respect to harness 20.

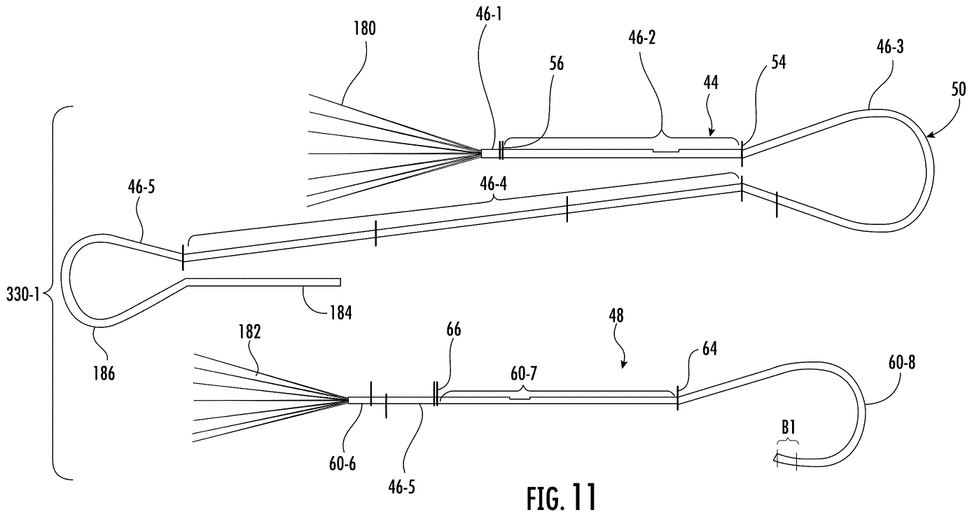

FIG. 11 is an exploded view of one example of tie-in riser 330-1, illustrating lines 44 and line 48 in a side-by-side relationship prior to splining and prior to the application of stitches 70. In one example implementation, line 44 is formed from a braided material such as ultrahigh molecular weight polyethylene braid. In one example implementation, the total length of line 44 is at least 50 cm and no greater than 100 cm, in some implementations, the total length of line 44 is at least 70 cm and no greater than 80 cm. In one example implementation, the tie-in point I formed by portion 46-3 the length extending from where the loop begins to the apex of the loop, wherein the length is at least 2 cm and no greater than 10 cm, and in some implementations, at least 4 cm and no greater than 8 cm. In some implementations, portion 46-2 has a length of at least 2 cm and no greater than 10 cm, and in some implementations, at least 4 cm and no greater than 8 cm.

In one example implementation, line 48 is formed from a braided material such as an ultrahigh molecular weight polyethylene braid. In one example implementation, the total length of line 48 is at least 30 cm and no greater than 60 cm, in some implementations, at least 40 cm and no greater than 50 cm. In some implementations, portion 60-8 has a buried length BL (the length extending through opening 54 and 64 and received within interior 58 and interior 68, wherein the buried length is at least 1 cm and no greater than 3 cm. In one example implementation, portion 60-6 has a length (a rise length) of at least 4 cm and no greater than 12 cm, and in some implementations, at least 6 cm and no greater than 10 cm., Such lengths or dimensions provide a sufficient degree of inter-nesting or splicing of line 44 and 48 for enhanced strength, provide a comfortable rise (the vertical distance or spacing between the leg loops and the belt 24), and provide a sufficient spacing or distance between belt 24 and the tie-in point eye 50. In other implementations, the lines 44 and/or 48 of tie-in riser 330-1 may have other lengths or dimensions. In other implementations, the lines 44 and 48 may be formed from other materials or have other weaves or constructions.

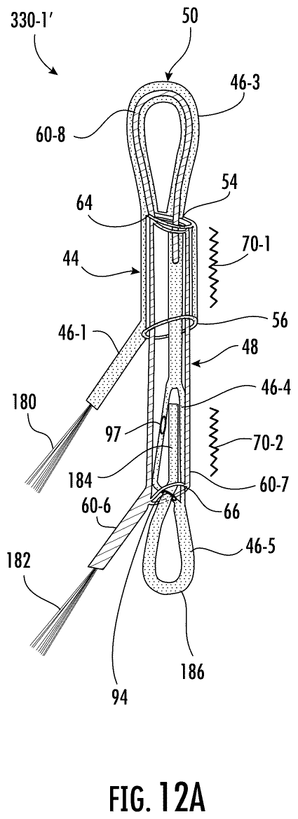

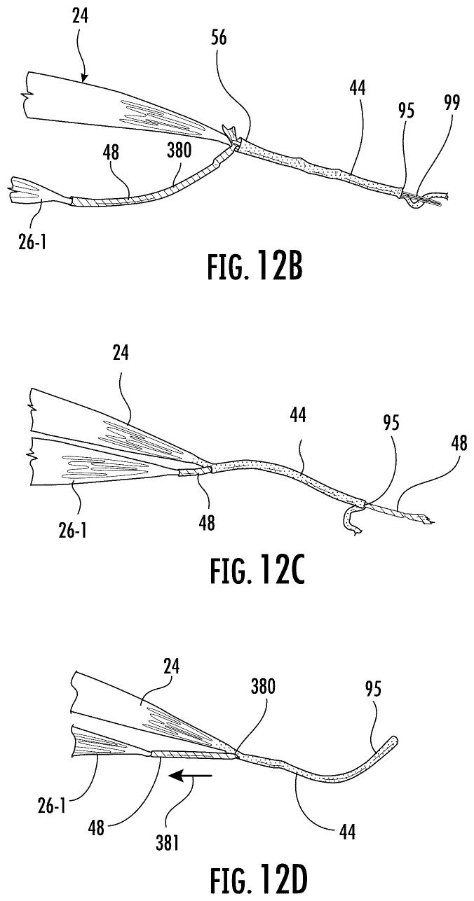

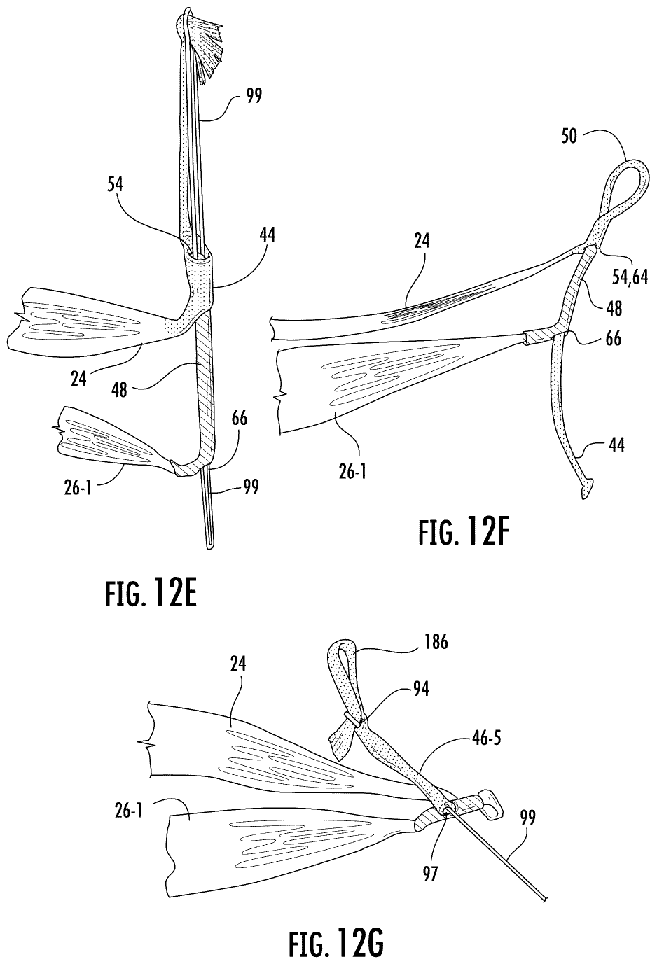

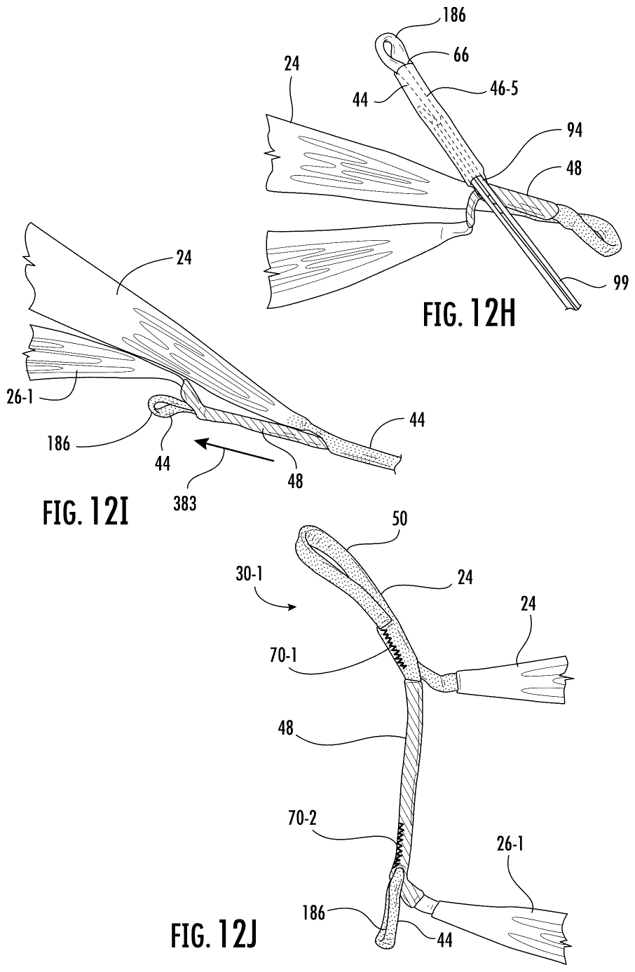

FIG. 12A is a perspective view of an example tie-in riser 330-1′ exploded and shown in section. Tie-in riser 330-1′ may be utilized in place of any of the above-described tie-in risers, including tie-in riser 330-1 and/or tie-in riser 330-2. Tie-in riser 330-1′ is similar to tie-in riser 330-1 except that tail 184 passes through a side opening 94 in portion of 46-5 or 46-4 and extends within and along portion 46-4. Such a configuration offers enhanced durability and strength for the connections forming loop 186. In some implementations, tail 184 may alternatively extend through side opening 94 in portion 46-5 and terminate within portion 46-5, not extending into portion 60-7. In the illustrated example, stitch 70-2 passes through portion 60-7, through portion 46-4 and through tail 184, within portion 46-4 to secure such portions in place, forming loop 186.

FIG. 12B-12J illustrate the splicing and merging of lines 44 and 48 to form a tie-in riser 330-1′. The method illustrated in such figures may likewise be utilized to form tie-in riser 330-1 and 330-2, except that tail 184 is alternatively inserted and tucked into portion 60-7 of line 48 external and alongside of portion 46-4. For ease of illustration, lines 46 and 48 are illustrated with distinct stippling.

As shown by FIG. 12B, line 48, illustrated as already being secured to leg loops 26-1, is marked at a location 380 spaced from its end by a distance greater than or equal to the length of portion 46-3. The splicing tool (sometimes referred to as a fid or needle) 94 is inserted through a side of line 44, at side opening 95 (or through an axial end opening of line 44), and is passed through and along line 44 before exiting the interior of line 44 at the created side opening 56. The end of line 48 is releasably secured to the end of splicing tool 99. In the example illustrated, the end of line 48 is passed through a ring or opening at the end of splicing tool 99.

As shown by FIG. 12C, tool 99 is pulled or retracted from line 44, pulling line 48 through and along the interior of line 44 with the end of line 44 passing through opening 95. As shown by FIG. 12C, line 48 is pulled in the direction indicated by arrow 381 until mark 380 is aligned with opening 56. This results in the end of line 48 ending within the interior of line 44. In some implementations, at such point in time, portions of line 48 may be stitched or otherwise secured to those portions of line 44 that receive line 48.

As shown by FIG. 12E, the splicing tool 99 is passed through the side of line 48, forming opening 66. The splicing tool is further passed within and along line 48 until exiting line 48 at a formed side opening 64 and at opening 54 in line 44. The end of line 44 is secured to tool 99. As shown by FIG. 12F, the splicing tool 99 is retracted or withdrawn from lines 44 and 48 through side opening 66, pulling the end of line 44 through openings 54 and 64 and through opening 66, forming tie-in eye 50.

As shown by FIG. 12G, splicing tool 99 creates and is inserted through a formed side opening 97 and is threaded or passed along and through the interior of portion 46-5, exiting the interior of portion 46-5 at opening 94. The end of line 44 is secured to tool 99. As shown by FIG. 12H, the splicing tool 99 is retracted and withdrawn from portion 46-5 of line 44, being pulled through opening 94, leaving enough of portion 46-5 beyond opening 66 to form loop 186. As shown by FIG. 12I, the compressed sleeve formed by line 48 is pulled in the direction indicated by arrow 383 to extend past the previously formed side opening 97, leaving tail 184 within the interior of both of portion 46-4 of line 44 and the interior of portion 60-7 of line 48. In other implementations, side opening 97 may be alternatively located so as to be located outside of line 48 when line 48 is extended and when loop 186 is formed

As shown by FIG. 12J, stitches 70-1 and 70-2 are applied. Although the method shown in FIG. 12B-12J is illustrated with lines 44 and 48 pre-attached or secured to waist belt 24 and leg loops 26-1, in other implementations, one or both of lines 44 and 48 may be splined or merged prior to securement to waist belt 24 (in the case of line 44) or to leg loop 26-1 (in the case of line 48). The waist belt 24 and the leg loop 26-1 of FIGS. 12B through 12I illustrate a stitching pattern formed into the waist belt 24 and the leg loop 26-1. In other implementations, other stitching patterns can be used. In other implementations, the waist belt 24 and the leg loop 26-1 can be formed without the stitching pattern. The above-described method may likewise be utilized to form the other tie-in riser for the harness.

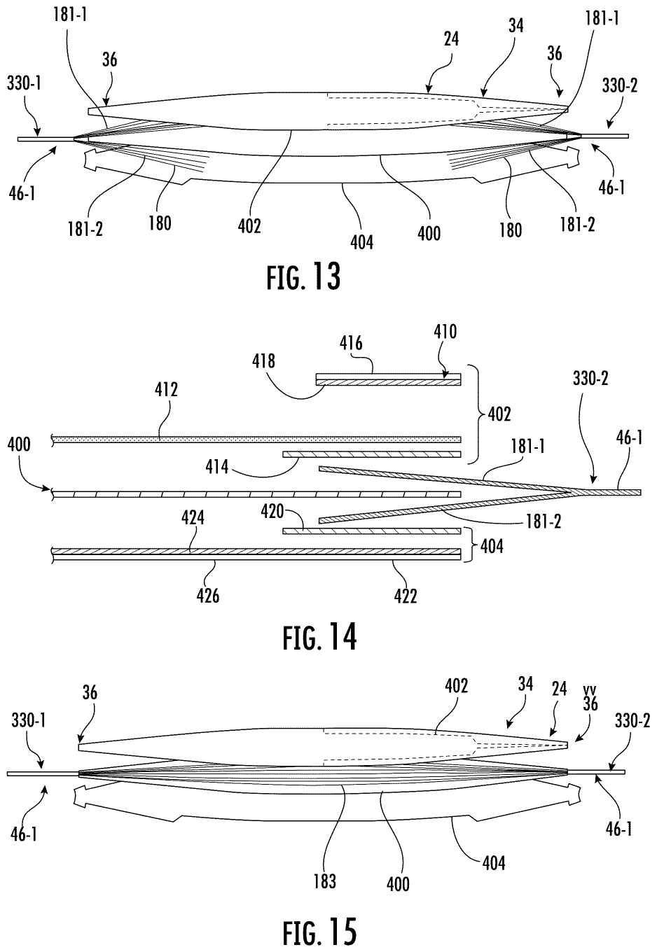

FIGS. 13 and 14 illustrate sample connection scheme for connecting end regions 36 of an example belt 24 to portion 46-1 of tie-in risers 30-1, 330-1 and/or for connecting end region 38 of leg loops 26 to portions 60-6 of tie-in risers 30-1, 330-1. FIG. 13 illustrates the example connection scheme connecting belt 24 to tie-in risers 330-1 and 330-2. In the example illustrated in FIG. 13, belt 24 comprises band panels 400, 402 and 404.

Panel 400 is sandwiched between panels 402 and 404. Panel 400 has a wide central portion and tapers to end regions 36. Panel 400 is further sandwiched between different portions 181-1, 181-2 of splayed end 180 of each of portions 46-1. Panel 402 has a wide central portion that tapers to end regions 36. Panel 402 extends over portions 181-1 of portions 46-1. Panel 404 has a wide central portion that tapers to end region 36. Panel 404 extends below portions 181-2 of portion 46-1. Panels 400, 402 and 404 are secured to one another provide an enhanced strength to band 34 for belt 24.

FIG. 14 is a sectional view illustrating one example of the right side of belt 24 shown in FIG. 13. In the example shown in FIG. 14, panel 402 comprises a stack of multiple films 410, 412 and 414 that are laminated to one another. Film 410 comprises a laminate formed by an outer layer 416 and an inner layer 418. Outer layer 416 comprises an ultrahigh molecular weight polyethylene film with the ultraviolet (UV) protective coating (protects against US damage) and greater abrasion resistance as compared to layer 418. In one example implementation, layer 416 comprises an ultrahigh molecular weight polyethylene film in the form of an ultralight composite textile material commercially available under the tradename ALUULA™. Layer 418 comprises a low density polyethylene film having a lower melting point than layer 416 and being softer than layer 416. Layer 418 facilitates bonding to film 412 while layer 416 provides protection or resistance against UV damage or abrasion.

Film 412 comprise the high-density polyethylene film having a higher melting point than layer 418. Film 412 also includes a UV protective coating and has enhanced abrasion resistance as compared to layer 418. Film 414 comprises a thermoplastic polymer configured to facilitate bonding of panel 400 and film 412. In the example illustrated, film 414 comprises a polyolefin having a melting point greater than layer 418 but less than layer 416.

Panel 400 is formed from material configured to facilitate bonding of portions 181-1 and 181-2 to panel 402 and 404. In one implementation, panel 400 comprises a material similar to that of layer 418. In one implementation, panel 400 comprises a low-density polyethylene film.

Panel 404 comprises films 420 and 422. Film 420 is similar to film 414. Film 422 is similar to film 410. Film 422 comprises a layer 424 which is similar to layer 418 and layer 426 which is similar to layer 416.

Although FIG. 13 illustrates the connection of tie-in risers 330-1 and 330-2 to opposite ends 36 of band 34 of belt 24, the construction shown on the right side of FIG. 13 and shown in FIG. 14 may be equally applied to the connection of portion 60-6 of line 48 of each of tie-in risers 330-1, 330-2 to end region 38 of each of leg loops 26-1 and 26-2. In such applications, splayed end 182 is split into two portions (similar to splayed end 181), wherein the two portions receive panel 400 therebetween as shown in FIG. 14. Similar to what is shown in FIG. 14, the two portions of splayed end 182 are likewise captured by panel 402 on one side and panel 404 on the other side.

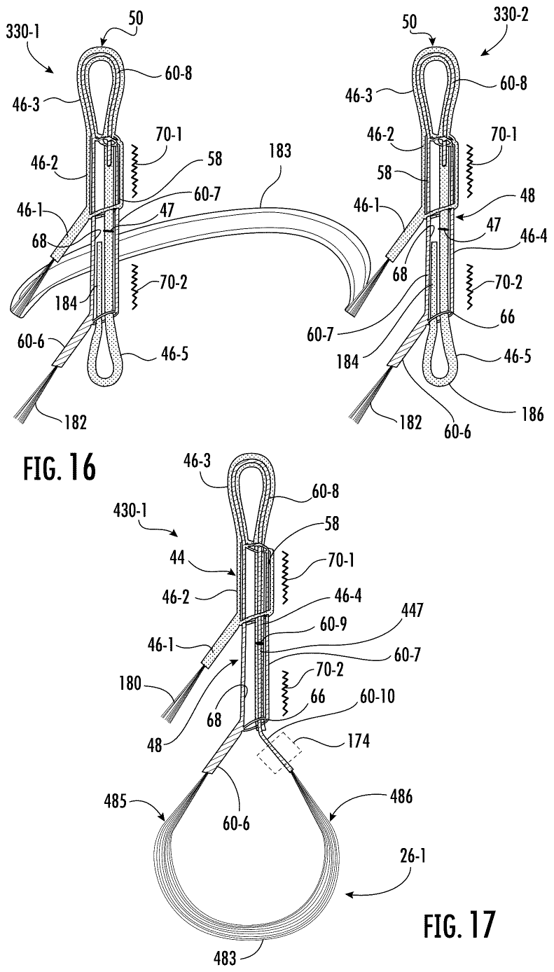

FIG. 15 is an exploded perspective view illustrating an example connection scheme for connecting end regions 36 of an example belt 24 to portion 46-1 of tie-in risers 30-1, 330-1 and/or for connecting end region 38 of leg loops 26 to portions 60-6 of tie-in risers 30-1, 330-1. FIGS. 15 and 16 illustrate the example connection scheme connecting belt 24 to tie-in risers 330-1 and 330-2. The connection scheme shown in FIG. 15 is similar to the connection scheme shown in FIGS. 13 and 14 as described above except that tie-in risers 330-1 and 330-2 share a single line 44 that is spliced with the first line 48 to form tie-in riser 330-1 and a second line 48 to form tie-in riser 330-2 as shown in FIG. 16. In such an implementation, portion 46-1 of each of the tie-in risers 330-1 and 330-2 have or form a splayed central portion 183 that extends, without interruption and without breaks between the two tie-in risers 330-1 and 330-2. As shown by FIG. 15, the splayed central portion 183 is sandwiched between panel 400 and panel 402 to form band 34 of belt 24.

The connection scheme shown in FIG. 15 may be likewise applied to each tie-in riser 430-1 for each leg loop as shown in FIG. 17. It should also be appreciated that the tie-in riser for the other leg loop 26-2 may have a configuration similar to that of tie-in riser 430-1 shown in FIG. 17. As shown by FIG. 17, tie-in riser 430-1 is similar to tie-in riser 330-1 except that line 44 omits portion 46-5 and that line 48 additionally comprises portion 60-9 and portion 60-10. Those remaining components of tie-in riser 430-1 which correspond to components of tie-in riser 330-1 are numbered similarly.

As with portion 46-4 of line 44 of tying riser 330-1, portion 46-4 of line 44 of tying riser 430-1 extends through and within both interior 58 of portion 46-2 and interior 68 of portion 60-7. In the example illustrated, portion 46-4 extends across and through a majority of the length of portion 60-7. In other implementations portion 46-4 may extend beyond the end of portion 60-7 or may be shorter, terminating within interior 58 of portion 46-2.

Portion 60-9 of line 48 continues from portion 60-8, extending within and exiting portion 46-4 through an axial end opening of portion 46-4. Portion 60-9 also exits interior 68 of portion 60-7 through opening 66. Portion 60-10 extends from portion 60-9, external to interior 68. Portion 60-10 comprises a splayed region along its length, having multiple spread apart individual fibers, strings or the like that form the splayed central portion 483. In the example illustrated, portion 60-6 also has multiple splayed individual or spread apart fibers, strings or the like which are the same as those splayed fibers of portion 60-10 in which also form splayed central portion 483. In other words, portions 60-6 and 60-10 do not form terminal ends of line 48 and are part of a single continuous, unbroken line having a particular intermediate portion which is unwound, splayed or spread apart as shown to form splayed central portion 483. This splayed central portion 483 is sandwiched between panels 400 and 402, similar to splayed central portion 183 shown in FIG. 15. Panel 404 may be added to complete the band of the leg loop 26-1. The unbroken nature of the leg loops 26-1 may provide enhanced strength.

In the example illustrated, the line 48 is provided by a continuous

unbroken loop of material. In other implementations, line 48 may have two terminal ends at particular points along its length, the ends being directly joined to one another and/or the ends being joined to line 44. As shown by broken lines, in one example implementation, instead of the leg loops 26-1 being continuous and unbroken, formed by uninterrupted line 48, the leg loops 26-1 may alternatively comprise a releasable connector 174 as described above with respect to harness 120. As discussed above, the connector 174 may comprise a quick release connector, a side release buckle, a loop and buckle (as described above respect to FIGS. 8-10), or other releasable connection mechanisms. In the example shown in FIG. 17, tie-in riser 430-1 is illustrated as having end region 46-1 with splayed end 180. In other implementations, tie-in riser 430-1 may share same line 44 with the other tie-in riser for the other leg loop as shown and described above with respect to FIG. 16. In such an implementation, splayed end 180 is replaced with the splayed central portion 183 shown in FIG. 16, wherein the splayed central portion 183 is sandwiched between panels 400 and 402 as described above with respect to FIG. 15. Panel 404 may also be provided. Thus, in some implementations, both of the leg risers and the leg loops are partially formed from a pair of continuous unbroken lines 48 in the form of loops (one for each of the leg loops) and a single continuous line 44 shared by both tie-in risers and forming the belt 24.

In some implementations, line 48 of tie-in riser 430-1 may omit the splayed central portion 483, wherein portions 60-6 and 60-10 are cut or otherwise terminate at locations 485 to instead form ends similar to splayed end 182, such that each of portions 60-6 and 60-10 have a respective splayed end 182. In such implementations, the splayed ends 182 of portions 60-6 and 60-10 are secured to one or more panels, such as panels 400, 402 and 404 in a fashion similar to that shown in FIGS. 13 and 14 to form the particular leg loop 26.

Although line 48 in FIG. 17 is described as being formed by a single loop, in some implementations, line 48 of tie-in riser 430-1 may alternatively be formed by a broken line 48 having two terminal end portions spaced from one another or overlapping one another at break 447 or at other locations. In some implementations, stitches 70-1 and 70-2, located on opposite sides of break 447, may be used to secure each of the two end portions of the broken line 48 to line 44 and/or to a remainder of line 48. In implementations where the two end portions overlap one another across break 447, a single stitch may concurrently pass through both end portions, securing each of the two end portions of line 48 to one another and to either or both of line 44 (portion 46-2) and a remainder of line 48 (portion 60-7). In other implementations, line 48 in FIG. 7 may be broken at other locations or may be replaced by more than one line, the multiple lines being secured to one another and/or to line 44. In some implementations the line 48 may be broken at portion 60-6 or portion 60-10, wherein the two ends are permanently attached to one another by glue, bonds, adhesives, patches, stitches or the like or where the two ends are releasably connected to one another by an intervening releasable connector, such as a quick release fastener, buckle or the like.

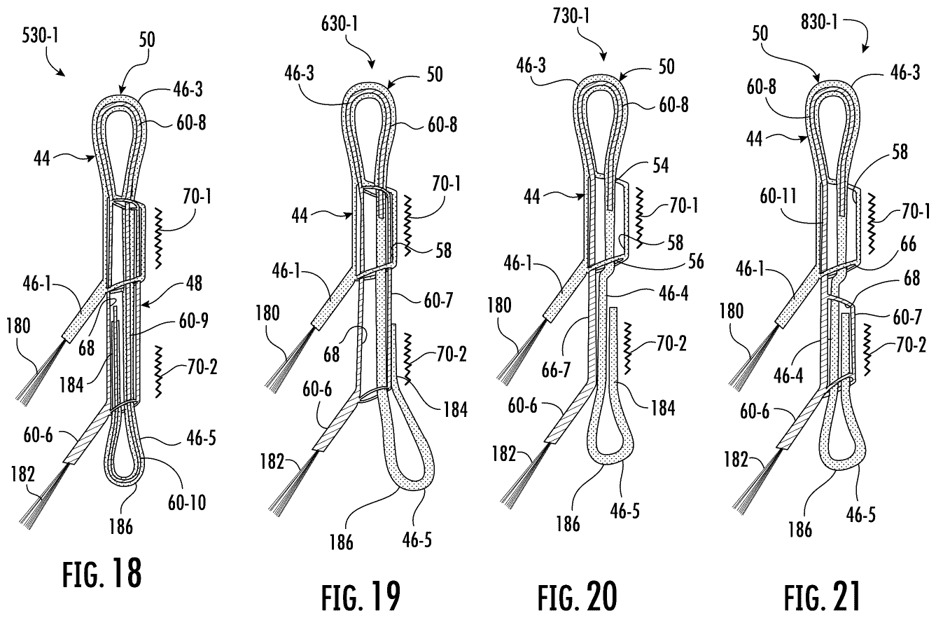

FIGS. 18-21 illustrate various other example tie-in risers that may be utilized in place of any of tie-in risers 30, 130 and 330 described above. FIG. 18 illustrates tie-in riser 530-1. Tie-in riser 530-1 is similar to tie-in riser 330-1 except that line 48 additionally comprises portions 60-9 and 60-10. Those remaining components of tie-in riser 530-1 which correspond to components of tie-in riser 330-1 are numbered similarly.

Portion 60-9 of line 48 continues from portion 60-8, extending within and exiting portion 46-4 through an axial end opening of portion 46-4. Portion 60-9 also exits interior 68 of portion 60-7 through opening 66. Portion 60-10 extends from portion 60-9, external to interior 68, within and along portion 46-5 and within tail 184. In the example illustrated, 60-10 projects through an axial end opening of tail 184 within interior in other implementations, portion 60-10 may terminate within tail 184. Portion 68-10 reinforces portion 46-5 to strengthen connection loop 186.

FIG. 19 is a partial sectional view illustrating an example tie-in riser 630-1. Tie-in riser 630-1 is similar to tie-in riser 330-1 except that tail 184 of portion 46-5 is secured to an exterior of portion 60-7 to form the connection loop 186. In the example illustrated, stitch 70-2 secures tail 184. In other implementations, tail 184 may be secured to portion 60-7 in other manners.

FIG. 20 is a partial sectional view illustrating an example tie-in riser 730-1. Tie-in riser 730-1 is similar to tie-in riser 330-1 except that portion 60-7 omits side openings 64 and 66, wherein portion 46-4 extends along an exterior of portion 60-7 and is secured to exterior of portion 60-7. In addition, tail 184 of portion 46-5 is secured to portion 46-4 and/or portion 60-7 to form the connection loop 186. In the example illustrated, stitch 70-2 passes through tail 184, portion 46-4 and portion 60-72 joined such portions. In the example illustrated, portion 46-3 extend through side opening 54 and exits interior 58 through side opening 56. Portion 460 does not pass through any interior of line 48. Likewise, interior 58 does not receive another interior of line 48. In such an implementation, line 48 may be formed from one or more materials which do not have a hollow interior.

FIG. 21 is a partial sectional view illustrating an example tie-in riser 830-1. Tie-in riser 830-1 is similar to tie-in riser 330-1 except that interior does not receive the interior 68 or portion 60-7. Rather, line 48 additionally comprises a portion 60-11 extending from in-between portion 60-7 and 60-8. Portion 60-11 enters opening 66 before entering and extending through portion 46-3 to form the tie-in eye 50.

Although each of the example tie-in risers shown in FIGS. 18-21 are illustrated as having portions 46-1 and 60-6 with splayed ends 180 and 182, respectively, in other implementations, each of such tie-in risers 530-1, 630-1, 730-1 and 830-1 may have a configuration similar to those shown in FIG. 16 and/or FIG. 17. In particular, splayed end 180 may be integral with the splayed end of the other tie-in riser to form the splayed central portion 183 as shown in FIG. 16. As discussed above, in such implementations, the two tie-in risers would share a single common line 44. The splayed central portion 183 may be secured to one or more panels, such as panels 400, 402 and 404 (shown in FIG. 15), in a fashion similar to that shown in FIG. 15, to form the band 34 of waist belt 24.

In some implementations, each of the tie-in risers 530-1, 630-1, 730-1 and 830-1 may additionally or alternatively be modified so as to omit portion 46-5 of line 44 and instead comprise a line 48 additionally comprising portions 60-9 and 60-10 as shown in FIG. 17 to form portions of a leg loop similar to that shown in FIG. 17. As discussed above, in such implementations, the splayed central portion 483 may be secured to one or more panels, such as panels 400, 402 and 404, in a fashion similar to that shown in FIG. 15, to form the particular leg loop. In some implementations, those tie-in risers 430-1, 530-1, 630-1, 730-1 and 830-1 comprising the portions 60-9 and 60-10 shown in FIG. 17 may omit the splayed central portion 483, wherein portion 60-6 has a splayed end 182 and wherein portion 60-10 also has a splayed end 182 and wherein the splayed ends 182 of portions 60-6 and 60-10 are secured to one or more panels, such as panels 400, 402 and 404 in a fashion similar to that shown in FIGS. 13 and 14 to form the particular leg loop 26.

Although multiple implementations are disclosed with each implementation having unique features or constructions, it should be appreciated that the individual features/constructions may be combined in different fashions or combinations to form different tie-in risers and different harnesses. For example, each of the above tie-in risers illustrated as having connection loop 186 may alternatively connect portion 46-5 to the first region of the leg loops 26 in a fashion similar to that described above with respect to FIG. 1 (where the portion 46-5 may have a splayed end integrated and permanently attached to the first and region of the leg loop) or similar to that described above with respect to FIGS. 3 and 4, where the different releasable connection (with connector 174-1) is used to join portion 46-5 to the first and region of the leg loops 26. Likewise, any of such implementations, the tie-in risers may alternatively have a configuration similar to that shown in FIG. 17, wherein the second line 48 is releasably or permanently/fixedly coupled are connected to the first end region of the leg loops 26. The tails 184 in each of the above-described example implementations may (1) be secured to portion 46-5, external to portion 60-7 when forming loop 186, (2) be secured within portion 60-7 alongside an external to portion 46-4 when forming loop 186, or (3) be secured within an interior of portion 46-5 or portion 46-4, either within portion 60-7 or external to portion 60-7. The loop 186 may receive buckle 190 (as shown and described above with respect to FIG. 7), may expand about bar 191 of buckle 190 which is to be received within a loop provided at the end of the leg loop, or may live about and be connected to another faster, such as a quick release buckle, side release buckle, or the like. In each of the above implementations, loop 186 may be omitted, where Intel 184 is directly connected to or affixed to portions of the leg loop (as described above with respect to FIG. 2).

Each of the above example harnesses form each of the two tie-in risers using two lines that are splined to one another. Because the two lines are splined, at least one of the lines extending through the other of the lines, the two lines fortify one another to increase the durability and strength of the tie-in risers without substantially increasing their overall volume or size. Despite such advantages, in some implementations, the above two described lines 44 and 48 that are splined to one another may alternatively be replaced with three or more lines. For example, the portion 46-4 of tie-in riser 330 (or 330-2) shown in FIG. 2 may be cut or otherwise be shorter in length (ending at break 47) where an additional line or segment (replacing the remaining length of the original portion 46-4 extending to portion 46-5) is spaced from portion 46-4 or overlaps portion 46-4 at the location or break 47 in FIGS. 2, 4, 6, and 16. In implementations where the length of portion 46-4 extending between break 47 and portion 46-5 is replaced with a separate and distinct line, the two stitches 70-1 and 70-2, located on opposite sides of the break 47, secure the individual segments or lines to line 48.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A harness comprising:
a leg loop;
a waist belt;
a first line comprising:
a first side opening;
a second side opening; and
a first interior between the first side opening and the second side opening; and
a second line,
wherein the first line further comprises:
a first portion connected to the waist belt;
a second portion forming the first interior;
a third portion entering the first interior through first side opening to form a tie-in point eye;
a fourth portion exiting the first interior through the second side opening; and
a fifth portion connected to the leg loop,
wherein the second line further comprises:
a sixth portion connected to the leg loop;
a seventh portion passing through the first interior of the second portion; and
an eighth portion extending along the tie-in point eye within the third portion.

2. The harness of claim 1, wherein the second line further comprises:
a third side opening;
a fourth side opening; and
a second interior between the third side opening and the fourth side opening,
wherein the seventh portion forms the second interior, and
where in the fourth portion enters second interior through the third side opening and exits the second interior through the fourth side opening.

3. The harness of claim 1, wherein the eighth portion enters the first interior.

4. The harness of claim 3, wherein the eighth portion extends within the fifth portion.

5. The harness of claim 1 further comprising a stitch extending through and joining the eighth portion to the first line.

6. The harness of claim 1 further comprising a stitch extending through and joining the second portion, the fourth portion and the eighth portion.

7. The harness of claim 6, wherein the stitch further extends through and joins the seventh portion to the second portion, the fourth portion and the eighth portion.

8. The harness of claim 1, wherein the fifth portion forms a leg loop connection loop.

9. The harness of claim 8, wherein the fifth portion has a tail that reenters the second interior to form the leg loop connection loop.

10. The harness of claim 9, wherein the eighth portion extends within the tail of the fifth portion and reenters the second interior.

11. The harness of claim 9 further comprising a stitch extending through and joining the seventh portion to the tail.

12. The harness of claim 11, wherein the stitch further extends through and joins the fourth portion to the tail of the fifth portion.

13. The harness of claim 8, wherein the fifth portion is secured to an exterior of the second line to form the leg loop connection loop.

14. The harness of claim 8 further comprising a buckle, wherein the leg loop connection loop receives and extends about at least a portion of the buckle.

15. The harness of claim 1, wherein the first portion comprises a splayed end region.

16. The harness of claim 1, wherein the sixth portion comprises a splayed end region.

17. The harness of claim 1, wherein the second line further comprises a ninth portion between the sixth portion and the seventh portion, the ninth portion comprising:
a third side opening;
a fourth side opening; and
a second interior between the third side opening and the fourth side opening,
wherein the fourth portion passes through the second interior.

18. The harness of claim 17, wherein the fifth portion comprises a tail and wherein the tail enters the second interior.

19. The harness of claim 1, wherein the first line and the second line are braided.

20. A harness comprising:
a leg loop;
a waist belt;
a first line comprising:
a first side opening;
a second side opening; and
an interior between the first side opening and the second side opening; and
a second line,
wherein the first line further comprises:
a first portion connected to the waist belt;
a second portion forming the first interior;
a third portion entering the interior through first side opening to form a tie-in point eye,
wherein the second line further comprises:
a fourth portion connected to a first end region of the leg loop;
a fifth portion passing through the first interior of the second portion; and
a sixth portion extending along the tie-in point eye within the third portion;
a seventh portion extending within and through the first interior, the seventh portion exiting the first interior; and
an eighth portion extending from the seventh portion and connected to a second end region of the leg loop.
